(19) United States
(12) Patent Application Publication
(10) Pub. No.: US 2010/0312581 A1
(43) Pub. Date: Dec. 9, 2010

(54) PROCESS AND SYSTEM FOR EFFICIENT ALLOCATION OF MEDICAL RESOURCES

(76) Inventors: Peter James Wachtell, Boise, ID (US); Sam Jacobs, North Shore City (NZ)

Correspondence Address: Zarian Midgley & Johnson PLLC, University Plaza, 960 Broadway Ave., Suite 250, Boise, ID, 83706, US

(21) Appl. No.: 12/794,922

(22) Filed: Jun. 7, 2010

Related U.S. Application Data
(60) Provisional application No. 61/185,118, filed on Jun. 8, 2009.

(51) Int. Cl. G06Q 10/00; G06Q 50/00; G06Q 90/00; G06F 17/30

(52) U.S. Cl. 705/3; 705/2; 705/500; 707/758; 707/812; 707/E17.009

(57) ABSTRACT

A system and method for efficiently allocating medical resources includes identifying patients to be seen by a medical facility in accordance with medical best practice guidelines and availability of medical resources. The method utilizes existing patient data, medical provider data and/or patient population data to create a new dataset used to rank patients for priority of contacting them. The patients are thus scheduled in a manner that the available resources are allocated for improved clinical outcome and/or greatest profit. The method may include dynamically changing the dataset to update the rank order of patients when any new data becomes available. The method may include changing weighting factors for patient rank order based on historical performance of the allocated medical resources, past performance of the patients, and/or criteria from the patient data record. The method may include automatically contacting patients in prioritized order to invite them to access medical resource.

This application claims priority to U.S. Provisional Patent Application Ser. No. 61/185,118, entitled “A PROCESS AND SYSTEM FOR OPTIMIZING THE ALLOCATION OF SCARCE MEDICAL RESOURCES”, filed Jun. 8, 2009 for Peter James Wachtell et al., the disclosure of which is incorporated herein by reference.

### BACKGROUND

The present disclosure relates generally to the field of providing medical resources to a population of patients and more specifically to a process for efficiently allocating scarce medical resources among those patients.

The manner in which medical facilities that offer a wide array of services, such as general practices or hospitals or in a broader sense, entire health organizations and health systems, are able to control the allocation of their resources has not changed greatly in the last several decades. To a great extent, the bulk of all services provided are provided to those customers or patients that proactively arrive seeking treatment. In many cases, the patients seeking treatment do not need treatment, or have needs that are clinically less important than other patients in the population. The result is that medical resources are not optimally allocated across the entire patient population based on either the clinical need or the availability of medical resources. In many cases, patients will overuse the medical resources available while other patients remain untreated for serious progressive diseases. The result is a squandering of scarce medical resources and a much higher cost to society for the non-treatment of preventable disease and for the non-treatment at an early disease management stage of the disease.

Various attempts at limiting access to scarce medical resources have resulted in creating waiting lists for treatments. These attempts have reduced the short-term economic costs. However reduced short-term costs are achieved at the expense of higher long-term costs, lower quality care, and poor clinical outcomes.

Fulfilling the need for efficiently allocating scarce medical resources has been attempted through adjusting traditional processes or through implementing a variety of different processes. The vast majority of these processes involve educating doctors and nurses on how to identify high priority patients based on their symptoms and on evidence based medical guidelines. Such processes have helped to some extent, but they have not changed the fundamental reality, which is that doctors and nurses generally see only the patients that present themselves to the medical facility to be diagnosed.

Although recall systems have been developed, these recall systems send recall notices based on the medical needs of the patient and best practice guidelines, with no consideration for the availability of limited resources for seeing the patient. This creates two results, which are prevalent in today's health care industry. The first result is long waiting times for patients because the resource is limited. This problem is aggravated because the patients that are seen frequently are also more often diagnosed with conditions that require follow up appointments, which are then automatically scheduled for recall appointments. As such, these patients are heavier users of the medical resources that are available. Thus, the second result is that a small percentage of the entire patient population is consuming much more than their allocable share of the medical resources.

Many patients need to gain access to the medical resources, but when faced with long wait times, they often give up or postpone seeking medical help. In many cases, this leads to more severe disease progression that can culminate in an emergency hospitalization of the patient and/or some worsened or more costly outcome. This lack of ability to appropriately schedule preventative care and disease management services can result in a much higher cost for the treatment of patients in the hospital instead of the patients receiving preventative care without going to the hospital.

In some areas of the medical profession, the lack of efficiency in allocating limited resources has spurred efforts to change the way in which medical services are offered. For example, for patients having specialized needs the efforts have resulted in the creation of disease specific clinics and specialty practices that attempt to offer specific disease prevention, such as those for diabetes management and cardiovascular care. The reallocation of medical resources from the general pool of medical resources to the treatment of specific high-cost diseases has provided a significant increase in the efficiency of treating those patients that have been diagnosed with these specific diseases. This has resulted in reduced waiting times and improved medical outcomes at lower costs for these particular patients.

Unfortunately, this improvement in the allocation of scarce medical resources appears to have been applied only to limited numbers of patients that have found their way through the general system for treatment, been properly diagnosed as belonging to a high priority disease group, and been fortunate enough to have gained access to a resource that has been designated for their disease's prevention and treatment. On the other hand, medical institutions, treatment programs, and the general system for treatment fall short in proactively identifying patients that: have not been seen/diagnosed and that are in sub populations that are at high risk; have been seen and diagnosed previously, but with whom follow up has been deficient; or are not participating in preventive disease management. There are many patients who should be proactively contacted, seen, diagnosed, and enrolled in special disease treatment programs that instead remain unidentified and fall between the cracks.

Thus, under the current and past medical treatment systems, nearly all of the patients seen are those that have proactively come to a medical facility of their own accord. These are the patients that are typically diagnosed and managed. Once under management, a patient may receive regular recalls as dictated by the disease management's best practice guidelines. However, even those patients that proactively come to a medical facility and are diagnosed with one condition do not get coordinated treatment for other conditions. This is because, unfortunately, each of the disease management teams rarely has information or insight into other prevention programs and the applicability of these programs to their patient. If the patient is participating in more than one of these treatment programs, the disease management teams for the respective programs rarely have access to status information for the patient with regard to programs other than their own. Sometimes this is the case even if the programs are conducted at the same medical facility. This often results in a patient being recalled with great frequency to see the dedicated medical resources for each disease that applies to them. For example, a patient may be in disease management programs for cardiovascular disease, diabetes, weight loss, smoking cessation, and skin cancer checks. Because the medical teams that deal with these disease management programs are each working separately, the patient may be recalled to the facility several times a month by one or more of these disease treatment groups. This has the possible negative effect of one or more of the teams overlooking adverse interactions of the various treatments and/or the adverse interactions of the diseases themselves. Additionally, each time the patient arrives; they utilize parking, reception, waiting room, nurse practitioner, treatment room, and billing resources. In additional to this, a patient that comes for multiple visits takes up resources that could otherwise be used to recall and diagnose individuals who have not yet proactively come to seek medical care.

Databases for storing electronic medical records are well known in the art, although they are not in use in every medical facility. This type of database is often known as an “Electronic Medical Record” or EMR. Most existing EMR systems are already designed for both ad hoc and automated queries to be run against each of the patient records, and a few EMR systems allow for such queries to be run against each record in the entire population of records. Most EMR systems allow the results of these queries to be viewed or printed.

In divergent fields, actions based on criteria from an entire population or database have been undertaken. For example, in the field of manufacturing, “just in time” production and inventory control utilizes criteria from the entire database of scheduled events and an inventory of parts to schedule ordering and delivery of parts for manufacturing production. Also, dynamic optimization is currently used in many information technology processes. However, before the discovery of embodiments described in the present disclosure, there does not appear to have been an adequate solution to the problems described above with regard to medical treatment systems that have been known and used up to the present time. That is, there does not appear to have been an adequately efficient allocation system or method for allocating available medical treatment resources in an optimal fashion across an entire population of individuals who require care. There does not appear to have been a system or method that takes into account criteria from an entire database or population of patients when allocating limited medical treatment resources.

### SUMMARY

Because of the above listed deficiencies in systems and methods of the past, there is a need for a system and/or a method for efficiently allocating medical treatment resources across an entire population needing to be managed for medical preventative care. The embodiments of the present disclosure achieve this at least in part by taking into account a more global view of the needs of the patient population. For example, the system and methods of the present disclosure recall patients based on weighing one patient's medical needs versus the medical needs of several other patients or even in comparison to the entire remaining patient population.

Another area in which the presently disclosed embodiments overcome the shortfalls of previously existing technologies is in identifying patients that are in sub populations that are at high risk. Past methods fall short in proactively identifying patients that are in these sub populations, especially when the patients have not yet been seen and diagnosed. As stated above, the past methods also fall short in identifying patients who have been seen and diagnosed, yet with whom there has been little or no follow up. The past methods are also deficient in identifying patients that do not appear to be participating in preventative disease management activities or who are not pursuing medical care in a proactive manner of their own accord. Embodiments of the present disclosure enable identification of these patients at a much higher level while at the same time applying the best practice guidelines to all or part of the entire population in order to determine which of the patients might otherwise fall between the cracks. Embodiments of the present disclosure identify these patients and facilitate proactively contacting them. In an embodiment, the system and methods can identify special disease treatment programs for patients based on patient data and available resources. In this way, the system and methods can enable calling these patients and proactively enrolling them in these special disease treatment programs in a manner that can improve allocation of the available resources to those patients with the greatest need or for which the greatest benefit can be achieved.

As stated above with regard to past methods of allocation, nearly all of the patients seen have been those who proactively come to the medical treatment facilities of their own accord. This portion of the patient population are typically diagnosed and managed for improved outcomes under the disease management's best practice guidelines, and these patients may be enrolled in more than one disease maintenance and prevention program. However, with past methods, any one disease management team rarely has insights as to the status of their patients in other prevention programs and the applicability of these programs to their patients. Without shared information, communication, and coordination between the prevention programs, several inefficiencies, including those listed above, may occur. The system and methods of the present disclosure facilitate information sharing and coordination between the disease management teams by identifying through one or more audits all the risk areas for patients that proactively visit the medical treatment facility and those that do not.

Methods of the past have fallen short in allowing for the results of multiple separate queries of patient records to be combined, weighted, and/or compared against one another. Furthermore, the EMR query tools that are provided are not sufficiently powerful to allow for the massive querying of the entire patient population and/or for all diseases at one time. In many cases, the EMR itself is not designed for the highly complex queries needed for the practice of embodiments of the present disclosure. If these queries were run against the EMR databases without the beneficial features of embodiments of the present disclosure, such complex queries would likely result in a system crash. On the other hand, with the methods that include machine-readable codes and instructions implemented in the system of the present disclosure, these complex queries can be undertaken to transform data into a new data set having a more useable form. The new dataset enables improved efficiency in medical treatment resource allocation.

By way of example, one embodiment of the disclosure is directed to a process for optimizing or improving efficiency in the allocation of scarce medical resources. In this embodiment, the process may include identifying the patients that need to be seen by a practice or other medical facility as determined by best practice guidelines. The process may also include rank ordering those patients so as to prioritize contacting and scheduling of the patients. In this way, the efficient use of available resources in the practice are improved or maximized for either best clinical result, increased profit, or both.

The process may include dynamically changing the rank order of these patients when any pertinent new data becomes available. The process may include changing the weighting of factors that determine the patient rank order based on actual historical performance of the medical facility, historic performance of the patient, specific resource details, and/or any criteria from the patient database. For example, resources may be more or less limited from time to time and may be accounted for by adjusting a weighting factor. Additionally or alternatively, past performance of the patient may be taken into account by adding or adjusting a weighting factor. Compensation for these variations may be accomplished by adjusting a weighting factor that affects the rank ordering process automatically. The process may include contacting and communicating with the patients to arrange the scheduling of an appointment for one or more medical reasons. The process may also include reviewing the medical outcome of these patient treatments and incorporating the results into the decision making process that prioritizes patients for future scheduling of appointments.

In a simple form, embodiments of the present invention may include an article of manufacture that includes a computer program storage medium readable by a processor and embodying one or more instructions executable by a processor to perform a method for efficiently allocating medical treatment resources. In this simple form, the method includes providing medical data for a plurality of patients; generating audit data comprising a subset of the plurality of patients and reasons for a medical professional examining the subset of patients; and prioritizing the subset of patients for order of treatment.

In another simple form, the article of manufacture is configured with a processor to perform a method including generating audit data comprising a subset of the plurality of patients and reasons for a medical professional examining the subset of patients; and prioritizing the subset of patients for order of treatment.

It is to be understood that prioritizing may include taking into account any of a variety of criteria, including compliance or lack of compliance with best practice guidelines, availability or lack of availability of medical treatment resources, time expenditure requirements for treatment, historical performance of the patients, historical performance of the medical treatment facility, weighting factors, other criteria, and combinations thereof, without limitation. It is to be understood that one or more of these or other factors may be taken into account in any order and in any combination.

In some embodiments, the step of prioritizing includes taking into account at least one of cost and revenue for a treatment procedure for the patients. In some embodiments, at least one of the cost and the revenue is based on costs and revenues of a prior period. In some embodiments, prioritizing includes taking into account a cost or expenditure of time based on a treatment procedure duration. In some embodiments, prioritizing includes taking into account availability of medical treatment resources, including availability of doctors and/or nurses.

In an embodiment, the article of manufacture implements a method that includes calculating a sum of revenues for treatment of each of a plurality of patients, calculating a sum of costs for the treatment of each of the plurality of patients, determining a sum of procedure durations for the treatment of each of the plurality of patients, determining at least one of a doctor availability, nurse availability and the availability of medical treatment facilities for the treatment of each of the plurality of patients. In this embodiment, prioritizing the patients includes prioritizing treatments of each of the patients based on the sum of revenues minus the sum of costs for the treatments and weighting the treatments based on at least one of procedure durations and availability of doctors and nurses for the treatments.

In some embodiments, prioritizing includes adjusting a weighting for a particular disease group. In some embodiments, prioritizing the patients includes using best medical practices criteria. In some embodiments, the method includes preferentially allocating resources to at least one patient that has not proactively sought medical treatment over allocating resources to another patient that has proactively sought medical treatment.

In another simple form, embodiments of the present disclosure may include an apparatus or system having a computer program storage medium that is readable by a processor and including one or more instructions that are executable by a processor to perform the methods described herein for efficiently allocating medical treatment resources. In this form, the apparatus may include a transformation module that is configured to create new data and compile the new data and existing data from a database into a new dataset. The apparatus may also have a prioritization module that is configured to rank the patients for assignment of medical treatment resources. In an embodiment, the prioritization module takes into account available medical treatment resources. In some embodiments, the prioritization module is configured to take into account an expenditure of time for a procedure or treatment.

In some embodiments, the apparatus or system includes a weighting module that is configured to weight variables used to prioritize the order of patients to be seen in the manner described herein. This weighting module can be programmed to allow a user to weight the variables considered, and thereby prioritize patients, in any desired manner.

In some embodiments of the apparatus or system, the prioritization module is configured to take into account at least one of cost and revenue for a treatment procedure for the patients. In some cases, at least one of the cost and the revenue is based on costs and revenues of a prior period.

Embodiments of the apparatus or system may include a best practice guidelines module that is configured to compare data from at least one of the dataset and the database to, for example, best practices guidelines established for a particular medical profession. The apparatus or system may include a message module configured to generate a message to be conveyed to a patient. In any of the embodiments, the apparatus or system may have a user interface, which may include at least one of a printer and a visual display. The embodiments of the present disclosure may include a computer apparatus or system having any number of components in which the visual display is a computer monitor, for example.

Another simple form includes a method of allocating medical resources with improved efficiency, which may be implemented by any suitable mechanism. In this simple form, the method includes: providing medical data for a plurality of patients; generating audit data comprising a subset of the plurality of patients and reasons for a medical professional examining the subset of patients; and prioritizing the subset of patients for order of treatment.

One embodiment of the method includes determining a revenue value for treatment of at least one patient; determining a cost value for the treatment of the at least one patient; determining at least one of 1) a time expenditure value for time required for the treatment of the at least one patient, and 2) an availability value based on availability of one or more medical professionals for the treatment of the at least one patient; and determining a priority value for the treatment based on the difference of the revenue value minus the cost value, and weighted by at least one of the time expenditure value and the availability value.

In some embodiments, the method may be implemented by calculating or otherwise determining the values for treatments of a plurality of patients. In this case, the method may include comparing the priority values of the treatments to determine which of the treatments has the highest priority. In some embodiments, one or more of the steps of transforming, prioritizing, and determining are performed automatically under software control.

Embodiments of the present disclosure can provide one or more of the following advantages: scheduling patients such that the medical provider's available resources are more fully utilized and are allocated to those patients that need them most; scheduling patients to be seen by a practice in a manner that increases or maximizes the profitability of the practice while also improving health outcomes; improving or optimizing the clinical outcomes for the patients that are scheduled and seen by a practice as indicated by the applicable best practice treatment guidelines; automatically taking into account new information and changes in the patient record or practice data as it becomes available to continuously improve efficiency or optimize the scheduling of patients and the allocation of resources in a dynamic manner; eliminating or reducing the need for doctors and nurses to think about or try to determine what patient groups require their focus; eliminating or reducing the time spent by doctors and nurses on issues such as data queries or patient contact tasks and allowing them to focus more on attending directly to patients and their medical needs; eliminating, minimizing, or reducing the allocation of practice resources to patients with low priority needs and to focus these resources on patients with high priority needs; filling a doctor and nurse's scheduled appointments with high value patients, thus making them unavailable for low priority patients who are actively overusing their services and the available health resources; and logically grouping the appointment of the patients such that multiple treatments and assessments covering multiple disease groups and medical needs can be performed in each scheduled appointment.

Other advantages of the present disclosure will become apparent from the following descriptions, taken in connection with the accompanying drawings, wherein, by way of illustration and example, an embodiment of the present disclosure is disclosed.

### BRIEF DESCRIPTION OF THE DRAWINGS

The drawings constitute a part of this specification and include exemplary embodiments to the disclosure, which may be embodied in various forms. It is to be understood that in some instances various aspects of the drawings may be shown exaggerated or enlarged to facilitate an understanding of the disclosure.

FIG. 1 is a flow diagram in accordance with embodiments of a method for efficiently allocating medical treatment resources by transforming patient medical records.

FIG. 2 is an example flow diagram including decision trees for a query during an audit of a population based on best practices for monitoring blood pressure.

FIG. 3 is an example table generated for a query of diabetes and at least one other factor in which the table provides a patient list for the current query, the number of other queries on which the patient is listed, and other useful identification and communication information.

FIG. 4 is a block diagram of a system of components and functions for implementing methods in accordance with embodiments of the disclosure.

FIG. 5 is a block diagram of a system of components and functions similar to FIG. 4 and including additional details.

### DETAILED DESCRIPTION

Detailed descriptions of embodiments of the present disclosure will now be provided. It is to be understood, however, that the present disclosure may be embodied in various forms. Therefore, specific details disclosed herein are not to be interpreted as limiting, but rather as a basis for the claims and as a representative basis for teaching one skilled in the art to employ the present disclosure in virtually any appropriately detailed system, structure, or manner.

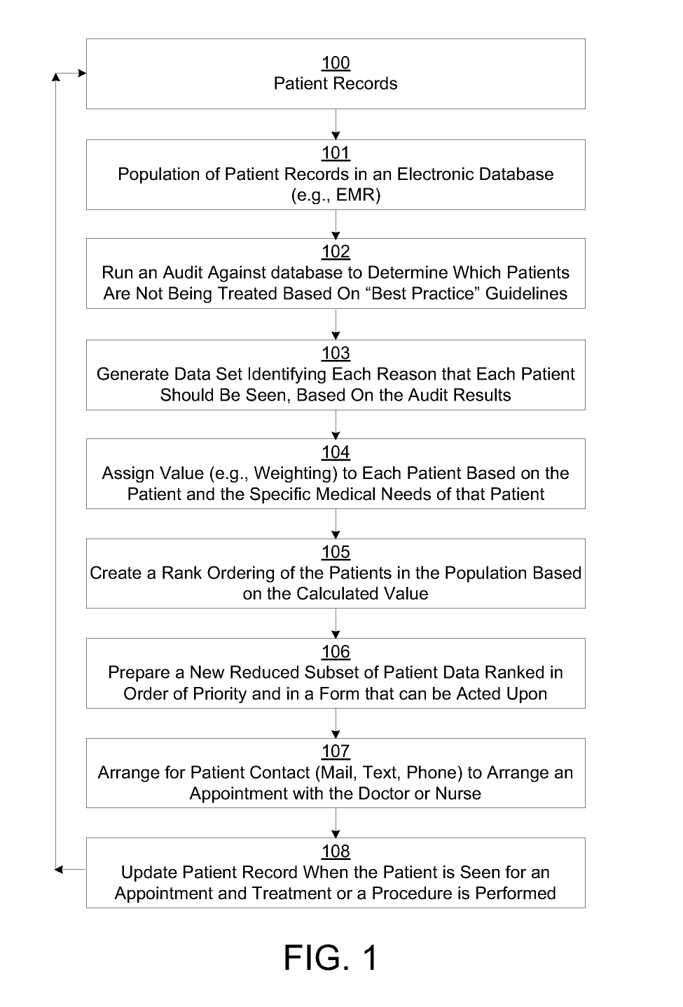

FIG. 1 is a flow chart illustrating one or more steps of a process that can be used to transform individual patient medical records into a more usable and/or condensed subset of data, according to an embodiment of the present disclosure. From this subset of data, medical resource allocation decisions may be quickly and accurately made to improve the health outcomes of a patient population.

Block 100 represents individual patient records that may include, but are not limited to, patient historical and current medical records, health status, lab reports, drugs prescribed, prescriptions fulfilled, medical procedures that have been undergone, outcome of those medical procedures, patient identifiable information including name, current address, past addresses, contact information, family medical history, height, weight, and ethnicity. These records may be in various forms, including paper records, electronic records or summarized versions with partial or incomplete portions of the records included, without limitation.

As illustrated at block 101 of FIG. 1, an electronic database can be populated with the patient records if the records are not already in suitable electronic form. Any suitable database can be employed. If, for example, the patient record 100 is in a paper file or other format that is not considered suitable for the querying processes discussed below, it can be converted to an EMR format or other electronic database that is machine readable, as in block 101. If the patient records already exist in a database, such as an EMR database, the step of block 101 may not be carried out.

The database of block 101 may include all or a portion of the individual patient records. The exemplary EMR database is a specialized type of database with a table structure that may be designed to run on a general-purpose computer of some form. Nevertheless, the design and organization of each EMR is complex and such data record storage applications are specific to the medical records of each medical provider. The EMR is typically available to the practice personnel either onsite or offsite with access via terminals and/or any suitable user interface.

As shown at 102 of FIG. 1, an audit of the patient records can be carried out to determine, for example, which patients are not being treated based on best practice guidelines. The audit may include running multiple, disease related queries against the database for some or all of the patient records in a population of patients that is being managed. These queries can be based on any suitable best medical practice guidelines, such as, for example, best practice guidelines as promulgated by the authority that is responsible for managing the health of the entire population of patients.

In an embodiment, a method of the present disclosure uses database query language to review each individual patient's record for the entire population or a subset of the population of patients in the database. Each query can be specific in focus to the measurement of the patient's level of compliance with a specific set of best practice guidelines for disease management as chosen, for example, by the medical provider. Unlike methods of the past, the present embodiments include combining multiple queries for the purpose of efficiently or optimally allocating scarce medical resources. Embodiments may include combining as few as two queries or as many as all queries for all or part of the entire population. Embodiments of the present invention provide the ability to achieve accurate results. This may be achieved through a highly complex series of queries such as by executing several easily understood and simple queries and combining the results, for example. The results of the queries may be aggregated and/or compared in any combination without limitation.

Most medical databases, such as EMRs, employ inexpensive database management systems, such as MySQL. These systems generally do not have the greater functionality of more sophisticated database systems, such as, for example, Microsoft Enterprise SQL. The techniques used for querying in the present disclosure can include running simple queries that can be performed on a standard medical database. The data from these queries can be imported into more sophisticated database systems via the web or any other suitable method. The sophisticated database can then be used to run more in depth queries using any suitable data mining techniques. For example, such data mining techniques can include generating a type of table called a data-warehouse. By building one or more of these data-warehouses, which are capable of being cross indexed, the data received from the standard medical database can be quickly and easily used to generate the audit data that is employed to calculated values and rank patients in the processes of the present application, without overwhelming the medical database and the server that it runs on. Data mining techniques using data warehouse tables are generally well known in the art and one of ordinary skill in the art would be able to apply these techniques to query a standard medical database given the disclosure provided herein.

Block 103 of FIG. 1 represents the subset of patients and their applicable individual medical data that is identified through the queries in block 102 as falling outside of best practice guidelines.

In an embodiment, some or all of the results for some or all of the queries can be combined. The result is the transformation of the data into a new form that carries new information in each patient record that was not previously part of that patient's record.

The new data may contain additional information that is in addition to any individual patient's medical record. This new data may include information that is relevant to prioritizing the patients, such as information related to adherence or lack of adherence to best practices guidelines, availability of medical treatment resources, time expenditure required for procedures and treatments, and other factors, without limitation. For example, the new data may include the calculation of doctor and nurse capacity utilization in the practice, room availability and diagnostic equipment utilization, and/or revenue and cost information about each procedure that is to be undertaken by the practice. Some of this data may be calculated by, for example, reviewing the actual practice performance in a prior period, or the practice manager may input any of this data manually.

Based on the data provided by the steps of blocks 100 to 103 (FIG. 1), the system and method of the present application can determine a value that can be used to prioritize the patients, as shown at block 104. Any suitable type of value can be employed, including monetary values, weightings, or any other number that can be used to derive a rank ordering of the patients. By way of example, as illustrated at block 104 of FIG. 1, the system and method can calculate an overall weighting for each patient.

Any suitable algorithm or technique can be used for determining the value. In an embodiment, the value for each patient can be calculated by taking into account any of the variables for prioritizing patients discussed herein, such as, the net revenues for caring for each patient, the medical needs of each patient, medical professional availability, and the time expenditure needed for the procedures.

In an embodiment, the value can be calculated for each patient based on the sum of the values of the revenues less costs weighted by doctor and nurse availability and time needed for each procedure. Each patient can receive a value based on the sum of the values of each procedure/treatment that is applicable to him or her at any given moment.

The variables for determining values in block 104 can be weighted in any desired manner. Weighting refers to the weight given to a particular variable, procedure, or the patient itself when determining the value or rank of any given patient. For example, various medical procedures can be weighted based on the net revenue that each procedure may generate. In another example, certain procedures, such as flu shots, may be assigned a higher weighting just prior to flu season, thereby increasing the number of patients seen for flu shots at the relevant time period so as to provide protection against the flu. Any variables used to calculate each patient's assigned value, such as doctor and nurse availability and/or a time needed for each procedure, treatment of a particular disease group or other variables, can be weighted in a similar manner based on the perceived importance in prioritizing the order for scheduling patients. Patients that are eligible to receive more higher weighted procedures or are associated with higher weighted variables may then have, for example, a higher calculated value, or overall weighting, assigned to them.

Some weightings may be assigned by algorithms, such as would often be the case for any overall weighting assigned to a patient as the value in block 104, which can be used to calculate rank ordering of the patients. Alternatively, weightings for any variable, including an overall weighting, can be assigned by the users of the system, such as a medical professional or regulatory authority. For example, elderly people during flu season could be required by a government agency to be assigned an overall weighting that will insure they are ranked so as to be scheduled for an appointment to receive a flu shot.

Thus, block 104 represents a step in the method for creating new data by assigning or calculating a value for each patient identified in block 103 by taking into account, for example, any relevant patient data in the EMR and data generated by auditing in block 102, such as the operational data of the medical resources being allocated across the patient population, the revenue data, and/or the expense data that is applicable to each patient and to each of the procedures that are applicable to that patient.

Block 105 represents the step of forming a list of the patients identified in block 103 that is rank ordered based on the values that are determined for each patient in block 104. As illustrated at block 105 of FIG. 1, some or all patients within the population are rank ordered (e.g. from a highest value to a lowest value). This ordering produces the list of priority by which patients may be contacted to make appointments for treatment and through which the patients may be assigned access to the medical resources needed for the treatment. Prior to the transformation of the patient data to include this information, it may be difficult if not virtually impossible to determine patient priority across the entire population. On the other hand, the ordering described in embodiments of the current disclosure allows the practice to efficiently or optimally allocate resources across any number of disease groups represented in the population. For example, the ordering may facilitate efficient or optimal allocation of the medical resources for all disease groups in the population.

Prioritizing the patients to be contacted in accordance with embodiments of the present disclosure can be important in some circumstances. For example, a typical 2-physician practice may have a population of 3500 patients to look after. In such a practice, the complete list of patients that need to be contacted for some specific medical purpose may be as high as 1600 in any given week. A doctor can see up to 150 patients in a week. A nurse can see approximately the same number. Therefore, without a prioritized list, the practice will most likely fail to identify and contact the patients that are of highest priority. On the other hand, with the methods of the present disclosure, the practice can focus on contacting patients from the prioritized or rank ordered list in order of highest to lowest priority. For example, the practice may wish to undertake a more reasonable task of mailing letters to the top 300 patients on the list every week. To the extent that response rates are high, the method in accordance with embodiments of the disclosure will enable the doctor's and nurse's time to be filled seeing the patients in the population that have the greatest need. If the response rate is low, the practice may need to mail or contact more of the patients from the top of the priority list. For example, the practice may need to contact the top 450 patients on the list each week. The practice may need to dedicate some portion of their staff and facility to deal with “walk in” patients and acute care. By controlling the number of patients that they contact each week, the practice can optimize the use of their facilities and staff. In this way, they can ensure that their available time is focused on highest priority patients and that their available resources are spent with those patients that are most in need of medical procedures and treatment.

As shown in block 106, the data associated with each patient in the newly ordered patient list can be reduced to include or show the information that will facilitate action by the appropriate medical personnel. The new reduced subset or dataset enables key personnel to act upon the data and to arrange for the patients to be seen in the correct order. This reduction of data can be very helpful because the amount of data that is available for each patient may be quite extensive, confusing to evaluate, and/or contain information that is not desirable/appropriate for viewing by all of the personnel involved in setting up appointments for the patient. For example, the subset may include only the patient data that is necessary and/or relevant to enable personnel to proactively contact the patient and set up an appointment to meet the patient's medical needs.

Block 107 represents the step of using the transformed patient data from block 106 to contact the patients. For example, the patients can be contacted in their ranked order to arrange for their access to the appropriate applicable medical resources that are available for treatment. As illustrated at block 107 of FIG. 1, the method in accordance with embodiments of the present disclosure includes arranging for patient contact for an appointment with a doctor or nurse. For example, the process may include automatically contacting each patient of sufficiently high rank on the list to warrant contact by the medical provider. This process may include automatically creating and sending either a customized templated letter and/or a text message from the medical provider to the patient. This contact letter and/or text message may invite the patient to call the medical provider to schedule an appointment with the doctor or nurse. A doctor or a nurse can be indicated based on whichever is most appropriate for the medical treatment or procedure to be performed. In addition, the processes and system of the present disclosure may include automatically sending text messages to the patients' cell phones, and/or automatically emailing the patients. The processes and system may be configured to generate a list with phone numbers for manually calling the patients. The telephone numbers and name information may also be transferred to an auto-dialer for rapid computerized calling with a recorded message requesting a return call. Alternatively or additionally, the name and number list may be sent to a third party for contacting the patients by the third party to proactively make appointments.

Block 108 of FIG. 1 represents an additional step that may be included in one or more embodiments of the present invention. In this step, after the patients are treated for their medical needs, their patient data record may be updated with the new information of their treatment. Then the system can automatically recalculate the appropriate value for ordering the patient and adjust each patient's new rank relative to other patients in the population. In an embodiment, the system can regularly (e.g. daily) re-audit the EMR system database looking for changes in the database that would impact the ranking of a patient. This type of update catches data changes due to actions by the patients themselves. For example, a patient that walks in at the medical treatment facility seeking medical treatment for the flu in the morning could be automatically accounted for in the afternoon by the automatic audit of the system. Such a visit may result in a blood pressure being taken, a BMI measurement being completed, and/or blood being drawn. This new data becomes part of the patient medical record, and it becomes part of the EMR database. The process of a daily audit of the database results in the new data being dynamically incorporated and accounted for in the ranking, such that as patients are seen, their rank ordering automatically changes and they are contacted for future appointments in an appropriate order given their new priority ranking. In this fashion, a medical practitioner does not need to monitor or manage the patient list at all. Rather, the medical practitioner can just arrive and see patients. All prioritization, allocation of medical resources, and scheduling may be done in the background by the operation of the processes and systems of the present disclosure. Simply removing the chore of managing the patient prioritization in a practice may free up as much as 25% of the doctor and nurse capacity.

To the extent that, upon occasion, there is a desire to allocate more available resources towards a particular disease group, the weightings associated with that disease group may be increased (e.g., to greater than 1) in the rank ordering process. This will allow a practitioner to partially or fully optimize the management of the health of the population for which he/she is responsible without having to dedicate limited staff to a particular function such as a dedicated disease clinic. An example for such a need might include the prioritization of flu vaccinations during the part of the year just prior to flu season.

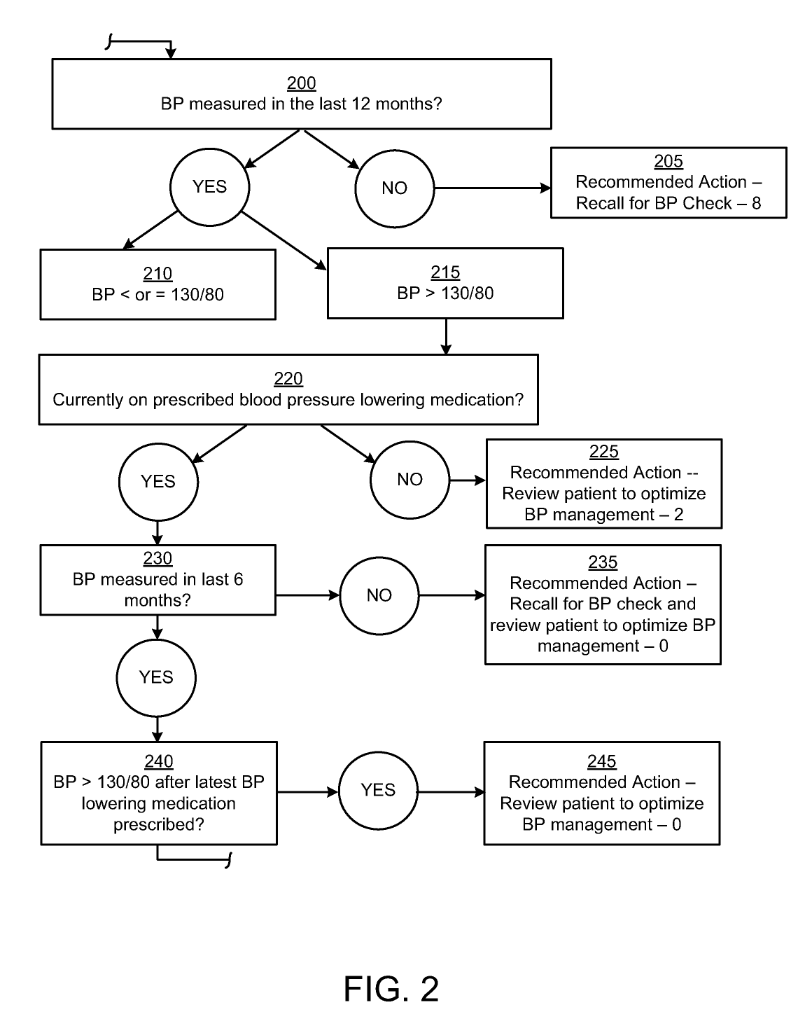

FIG. 2 is an example flow diagram of a portion of a method for implementing the step of block 102 in FIG. 1. In this example, the portion of the method includes a decision tree for a query of the population regarding whether blood pressure (BP) has been checked and whether it was high. Machine-readable code in the form of software, firmware, or any combination of software and firmware may be used to implement the methods of the present disclosure. The code may implement decision trees for any number of query types. The example flow diagram of FIG. 2 is for a disease group of patients within the population that have been determined to have diabetes (and excluding those with renal failure), and is configured to determine a subset of the patients within this disease group that fall outside of the best practice guidelines for monitoring/managing blood pressure. The example flow diagram illustrates how the method may distinguish why each patient has fallen outside the best practice guidelines based on the way the patients have been managed and the ways they have responded to treatment for high blood pressure.

In this example, block 200 represents the question of whether the patient's blood pressure has been measured in the past twelve months. When the answer is “no”, then the system and method recommends recall of a blood pressure check, as indicated at block 205. It is noted that in this disease group/query there are 8 patients that fall outside the best practices guidelines for a blood pressure check in the past twelve months, as indicated in block 205.

If the patients' blood pressure has been measured in the past twelve months, then the system and method look for whether the patients' blood pressure is above a predetermined limit. If the blood pressure is below the limit, then the patient is categorized as indicated at 210, as requiring no action. These patients may be marked or counted similar to those of block 205. If the patient's blood pressure is above the limit, then the patient is categorized as indicated at block 215. These patients can likewise be marked and/or counted, and the system and method looks at whether these patients are on blood pressure lowering medication, as indicated in block 220.

If the patients having high blood pressure are not on blood pressure lowering medication, then the system and method recommends reviewing the patient to optimize or improve blood pressure management, as indicated at block 225. As shown in block 225, the system counted 2 patients that fall short of best practices guidelines for not being on blood pressure medication even though their blood pressure was measured within the last twelve months to be above the best practices limit.

For patients with high blood pressure that are on blood pressure lowering medication, the system and method looks at whether blood pressure has been measured in the past six months, as indicated at block 230. If not, the patient is categorized accordingly and the system and method recommends a recall for a blood pressure check and a review to optimize or improve blood pressure management, as indicated at block 235. As shown at 235, no patients fell outside the best practices guidelines at this stage of implementing the query.

For patients having high blood pressure, that are on blood pressure lowering medication, and that have had their blood pressure checked in the past six months, the system and method looks at whether the blood pressure is higher than the predetermined level when the patient is on the blood pressure lowering medication, as indicated at block 240. If it is, then the patient is categorized as indicated at block 245, and the system and method recommend that the patient be reviewed for optimal or improved blood pressure management. As indicated in block 245, there were no patients in this query that fell outside the best practices at this stage of the process.

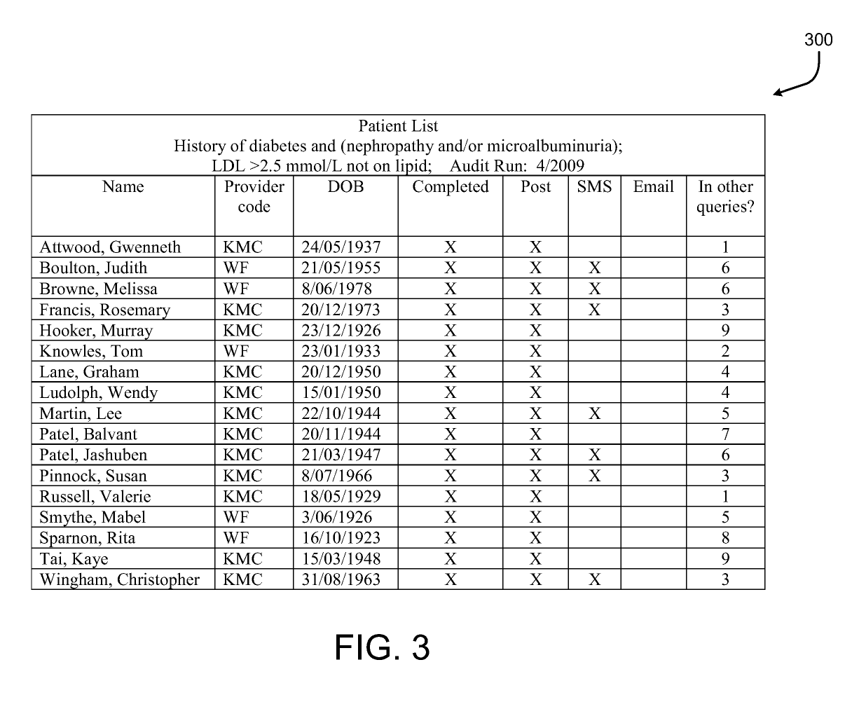

Any of a variety of queries with decision trees and categorizations of why best practices guidelines were or were not met may be implemented under software and/or firmware control for a variety of disease groups, combinations of disease groups, or for the population as a whole, by the system and methods of the present disclosure. The system and methods can add up all the instances for falling outside the best practices guidelines for each patient, and a need for treatment priority ranking of the patients can be determined based on the risk associated with falling outside best practice guidelines in the various queries. One example of this is shown in FIG. 3 and is described below. Appropriate weightings for availability of resources or other factors may also be undertaken to establish the rank order of the patients.

FIG. 3 shows an example of a dataset in the form of a table 300 that may be generated in accordance with the step of block 103 of FIG. 1. The table 300 illustrates a simplified dataset, which is a subset of the population. The table 300 is just one graphical example having a patient list and a select subset of data that may be created. The example of table 300 is based on another subset in the form of a disease group within the population that may be found by performing a process similar to that shown and described with regard to FIG. 2 and the step of block 103 in FIG. 1.

A machine-readable code or instructions for implementing the methods and generating the table 300 may be any computer software code in any language and/or may include firmware. The actual machine-readable code may be configured to transform existing data and create a newly formed dataset from, for example, the combination of individual patient data, medical provider facility data, and/or the overall patient population data. The machine-readable code may be configured to identify patients and provide a ranking of any or all of the patients by way of the queries and recommended actions, an example of which is illustrated in FIG. 2.

The machine-readable code, may further be configured to generate the exemplary table 300 to include identified patient lists, as shown in FIG. 3. The listed patients fall outside of the best practice guidelines for treatment of the disease for which the table was generated. Other tables, which may include tables of data for combinations of disease groups, can also be generated to show patients that fall outside the best practice guidelines for other diseases or combinations of diseases. In the rightmost column of table 300, the number of additional queries for which each patient falls outside best practices guidelines is indicated. That is, each patient listed in table 300 falls outside the best practice guidelines for the subject disease of table 300 plus the number of diseases or queries indicated in the rightmost column of table 300. This number can, for example, be used for weighting and/or ranking any or all of the entire population of patients being managed.

The machine-readable code may be configured to generate and populate a templated letter or other message. The code can be configured to automatically generate and tailor the letter or other message to include appropriate instructions and an invitation for the disease diagnosis and/or treatment needed. The letter or other message may be mailed or automatically sent to a patient based on the rank accorded to the patient. In some embodiments, the sending order may be based on the rank order, which may include any weighting for taking into account the availability of practice resources.

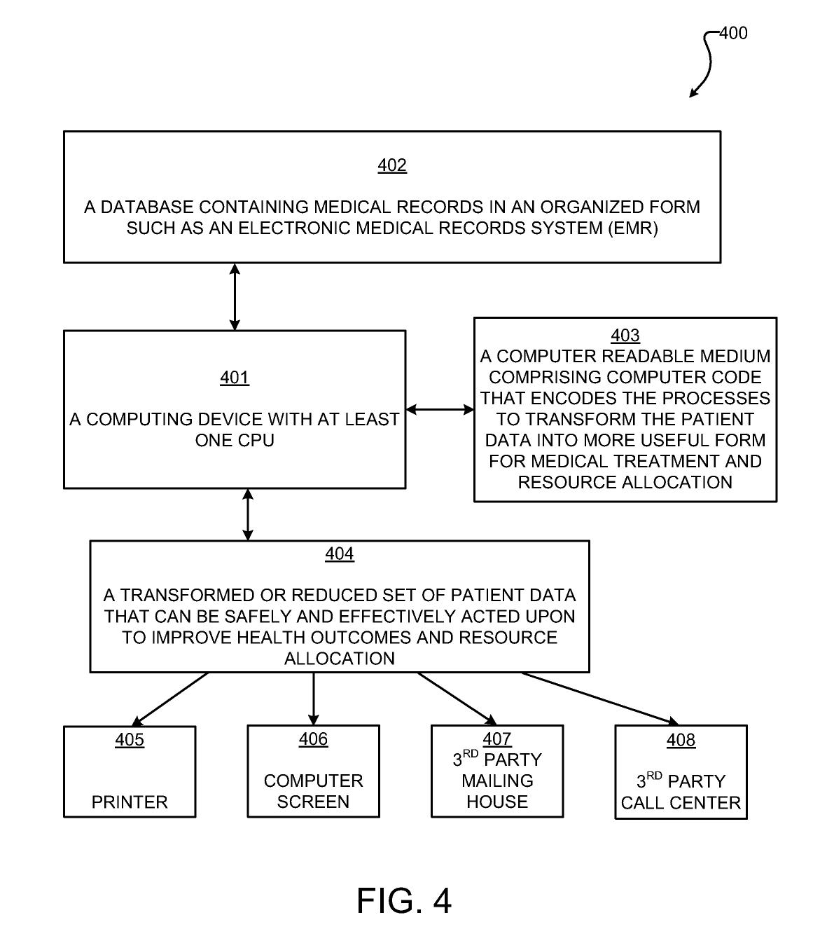

FIG. 4 illustrates a relationship between the methods disclosed herein and an example of a system 400 for carrying out the methods. The system 400 can include a general-purpose computer, as indicated by block 401, that may range in size or capability from that of a modestly powerful personal computer to that of a massive mainframe computing system. The computer may include software that contains or has access to patient medical records organized in a database. The medical records may be in the form of one or more databases of an Electronic Medical Records (EMR) system, as shown in block 402. As shown in block 403, a process for transforming the generalized patient record data into a new and more useful form, as described in this disclosure, may be encoded in a machine-readable code of instructions, as shown in block 403. The machine-readable or computer code may be loaded onto the computer and the processes for which the code is configured may be implemented by a central processing unit. The code may be configured to receive, manipulate, and/or send data stored in the patient records database or EMR. The code may also be configured to act in a predetermined manner in response to newly created data. The resulting newly created data may be stored in the computer in an electronic form as shown in block 404. The new data may then be used to allocate resources optimally or at least more efficiently than without the system and methods of this disclosure.

Improved efficiency and allocation of resources may be achieved in a number of ways, which include proactively contacting at least some of the patients according to their assigned rank. Contacting these high priority patients may include sending the information from the computer to a mailing service, as indicated at block 407, in a preformatted manner to enable automated mailings to patients. Alternatively or additionally, allocation of resources may be achieved by simply printing the information to a printer that is connected to the computer, as indicated at block 405, and then instructing medical personnel to manually allocate the resources. Further alternatively or additionally, the resources may be allocated by simply showing the medical personnel the newly transformed data on a display, as indicated at block 406, such that they can then manually schedule or call patients in a prioritized order. Further alternatively or additionally, all or a portion of the reduced patient dataset may be sent to a call center, as indicated at block 408, to have patients called and appointments set in order of priority. All new patient data can be quickly entered into the computer's database by either manually entering it from the physical records or by having the data entered directly into the EMR system as the patient is seen.

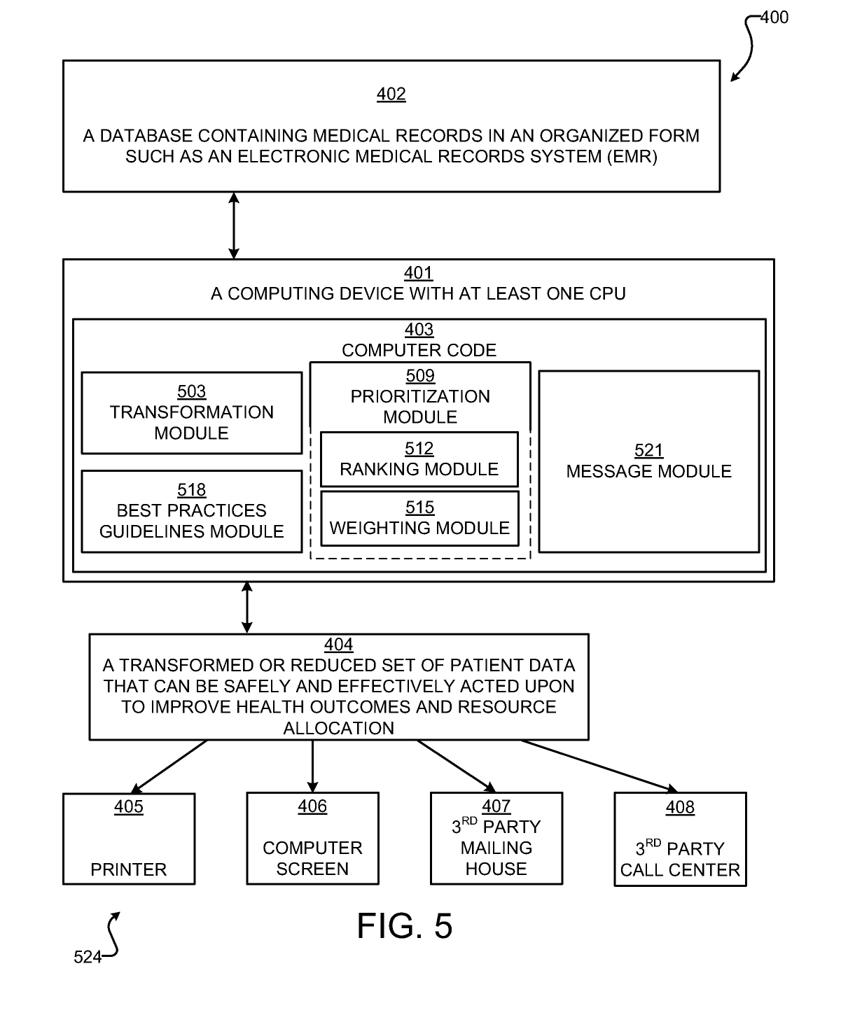

FIG. 5 is a block diagram of the system 400 similar to FIG. 4, and including additional details with regard to the machine-readable instructions or computer code 403 that may be stored in the computing device 401. The code may alternatively or additionally be stored on a remote device, or on a removable device. The code may be organized in any of a variety of ways.

For example, there may be a transformation module 503 that acquires or otherwise receives data from an existing database. This may be achieved through manual or automatic input. The transformation module 503 can selectively take pertinent data from the database, create new data, and form a new dataset that is useful for allocating medical treatment resources efficiently. The new data that is created may include any of the data relevant to prioritize patients discussed herein, such as availability data with regard to doctors, nurses, medical treatment facilities, and machines. The new data may also include time expenditure data for one or more procedures, diagnoses, etc. The transformation module may also be configured to assign weightings or values based on best practices guidelines and/or other criteria. The assigned weightings or values may also be part of the new data that makes up the new dataset created through the transformation module 503.

As shown in FIG. 5, the prioritization module 509 may include a ranking module 512 and a weighting module 515. The ranking module 512 functions to place patients in order based on the values assigned by the weighting module. The weighting module 515 functions to assign weighting factors to procedures or treatments, and/or to assign values or overall weightings to patients.

The best practices guidelines module 518 may form part of the transformation module 503 or any other module. Alternatively, the best practices guidelines module 518 may be separate, but operably connected to the other modules. The best practices guidelines module 518 may include best practices guidelines or may have access to the guidelines in a remote file for comparison to the treatment received by the patients in the database or in the dataset. This comparison may be used in prioritizing the patients.

Once the patients have been prioritized, the message module 521 can automatically generate a message and send it to the patients generally in order from highest priority to lowest priority. Alternatively or additionally, the message module 521 may generate a letter and have it printed on a printer 405 for sending by mail. The message module may generate a message on a computer screen and/or to be forwarded through any number of intermediaries to the patient. As such the system 400 may include any of a variety of user interfaces 521 such as printers, computer screens, etc., without limitation.

Connecting lines and arrows generally indicating flow paths throughout the drawings are not to be considered as limiting. Flow along connecting lines can be in any direction. While the processes and systems of the present disclosure have been described in connection with preferred embodiments, this is not intended to limit the scope of the disclosure to the particular forms set forth, but on the contrary, it is intended to cover such alternatives, modifications, and equivalents as may be included within the spirit and scope of the disclosure as defined by the appended claims.

What is claimed is:

1. An article of manufacture comprising a computer program storage medium readable by a processor and embodying one or more instructions executable by a processor to perform a method for transforming patient data into a form that can be used to efficiently allocate medical treatment resources, the method comprising:
providing medical data for a plurality of patients;
generating audit data comprising a subset of the plurality of patients and reasons for a medical professional examining the subset of patients; and
prioritizing the subset of patients for order of treatment.

2. The article of manufacture of claim 1, wherein generating audit data comprises evaluating the medical data based on best medical practice criteria.

3. The article of manufacture of claim 1, wherein prioritizing the patients comprises accounting for available medical treatment resources.

4. The article of manufacture of claim 1, further comprising allowing a user to weight variables that are used for the prioritizing.

5. The article of manufacture of claim 1, wherein the generated data further comprises at least one of medical professional availability, medical facility availability, diagnostic equipment utilization, and revenue and cost information about medical procedures for each patient.

6. The article of manufacture of claim 1, wherein prioritizing the patients comprises assigning a value to each patient and generating a rank ordering based on the assigned values.

7. The article of manufacture of claim 6, wherein assigning a value to each patient comprises:
calculating a sum of revenues for treatment of each of the patients;
calculating a sum of costs for the treatment of each of the patients; and
wherein ranking the patients comprises prioritizing treatments of each of the patients based on the sum of revenues minus the sum of costs for the treatments.

8. The article of manufacture of claim 6, wherein assigning a value to each patient further comprises:
determining a sum of procedure durations for the treatment of each of the patients; and
determining at least one of a doctor availability and a nurse availability for the treatment of each of the patients; and
calculating the value based on at least one of procedure durations and availability of doctors and nurses for the treatments.

9. An apparatus comprising a computer program storage medium readable by a processor and embodying one or more instructions executable by a processor to perform a method for efficiently allocating medical treatment resources, the apparatus comprising:
a transformation module configured to create new data by receiving medical data for a plurality of patients from a database and generating audit data comprising a subset of the plurality of patients and reasons for a medical professional examining the subset of patients create new data, and forming a new dataset comprising the new data; and
a prioritization module configured to rank the patients for assignment of medical treatment resources;
wherein the prioritization module takes into account available medical treatment resources.

10. The apparatus of claim 9, further comprising a weighting module configured to weight variables relevant to calculating rankings for the patients.

11. The apparatus of claim 9, wherein the prioritization module is configured to take into account at least one of cost and revenue for a treatment procedure for the patients.

12. The apparatus of claim 9, further comprising a best practices guidelines module configured to compare data from at least one of the dataset and the database to a best practice guideline.

13. The apparatus of claim 9, further comprising a message module configured to generate a message to be conveyed to a patient.

14. A method of allocating medical resources with improved efficiency, the method comprising:
providing medical data for a plurality of patients;
generating audit data comprising a subset of the plurality of patients and reasons for a medical professional examining the subset of patients; and
prioritizing the subset of patients for order of treatment.

15. A method of claim 14, wherein the generated data further comprises at least one of medical professional availability, medical facility availability, diagnostic equipment utilization, and revenue and cost information about medical procedures for each patient; and wherein prioritizing the patients comprises assigning a value to each patient and generating a rank ordering based on the assigned values.

16. The method of claim 14, wherein prioritizing the subset of patients further comprises preparing a new subset of data ranked by priority.

17. The method of claim 16, further comprising arranging for patient contact based on the new subset of data.

18. The method of claim 17, wherein at least one of the steps of providing, generating, prioritizing and arranging are performed automatically under software control.

19. The method of claim 14, further comprising updating a patient's medical data after the patient is treated, and repeating the step of prioritizing to determine a new order of treatment.

20. A computer system comprising:
a processor;
a database accessible by the processor, the database containing patient medical records; and
a computer readable storage medium comprising a set of instructions configured to carry out the process of claim 14.
